(19) United States
(12) Patent Application Publication
(10) Pub. No.: US 2008/0000572 A1
(43) Pub. Date: Jan. 3, 2008

(54) Shrink wrap labeling system and method

(76) Inventor: George A. Lopez, Campbellton, TX (US)

Correspondence Address: Eric W. Cernyar, Suite 1500, 700 N. St. Mary's St., San Antonio, TX, 78205, US

(21) Appl. No.: 11/476,336

(22) Filed: Jun. 28, 2006

(51) Int. Cl. B32B 37/00

(52) U.S. Cl. 156/86; 53/441; 428/34.9

(57) ABSTRACT

A method and kit are provided for labeling an object having a generally rounded outer surface, such as a cowboy lariat. The kit includes a label, substantially transparent heat-shrinkable tubing, and packaging suitable for storing, displaying, and distribution. Use of the invention is quick and efficient, providing a durable and easily recognizable label for imprinting an identifying mark thereon.

### BACKGROUND OF THE INVENTION

1. Field of the Invention

The present invention relates to a system and method for labeling objects with shrink wrap. More specifically, the present invention comprises, inter alia, a novel retail kit including heat-shrinkable tubing, as well as method of labeling generally rounded objects such as rope, cord, tubes or shafts.

2. Background of the Invention

A cowboy's rope, also called a lariat, is an important tool used in professional rodeo competitions as well as ranches. The rope is usually light and strong with a smooth, hard finish, and made from fine quality hemp or nylon. In professional competition, the rope is used for roping calves and steers, but on a working ranch it may be used primarily for catching large animals such as cattle and horses.

The rope varies in length from thirty five to fifty feet, and its desirable characteristics include durability and consistency. At one end of the rope is a running knot or a metal ring by means of which a loop or noose is made. The roper throws the loop from as far away as thirty feet, targeting the horns or the feet of an animal, then draws the rope taught.

At professional rodeos, a cowboy's rope tends to wander away. Not surprisingly, in the fast-paced, hectic world of competition, the lariat might get misplaced, lost, or even pilfered amidst the excitement and chaos of competition. These ropes are not cheap, either; a quality rope can cost fifty dollars, so frequently replacing ropes can quickly add up.

There is a need for a quickly deployable labeling system and method for identifying ropes or lariats in addition to other generally rounded objects. The present invention addresses this need by providing an inexpensive labeling system and method for marking a cowboy's rope or other object with an identifying label.

### SUMMARY OF THE INVENTION

The present invention provides a novel system and method for, inter alia, labeling generally rounded objects such as ropes (e.g., lariats), cord, tubes, shafts, string, handles, cable, and other similarly-shaped objects. The invention includes a method for labeling these objects comprising sliding heat-shrinkable tubing about the outer surface of an object, positioning a label on that outer surface, and heating the tubing at least until the tubing shrinks and holds the label stationary relative to that object's between the inner surface of the tubing and the surface of the object.

Although heat shrinkable tubing was designed for insulating and securing contact between wires in the electrical arts, the present invention is aimed at the use of heat-shrinkable tubing in non-electrical arts rather than with regard to conductors. Thus, the object to be labeled need only be of a generally rounded shape such that the heat shrinkable tubing may be fitted about the object and later shrunk such that the tubing will conform to the shape of the object.

According to one feature of the invention, the label may be held stationary against the object by inserting the label into holding slits in the tubing. Alternatively, on in conjunction therewith, an adhesive may coat the back of the label to facilitate positioning of the label on the object's surface.

According to yet another feature of the invention, a labeling template may be downloaded from the Internet to simplify and assist with imprinting the label with an identifying mark. Such a template both predefined parameters (such as margin widths or label sizes) as well as user-configurable parameters such as font style, size and color.

Moreover, the invention discloses a kit of components for labeling objects that includes a label, heat-shrinkable and substantially transparent tubing, and packaging suitable for storing, displaying, and distribution. One feature of the invention further comprises adhesive that coats at least a portion of the label to facilitate the placement of the label on the object to be labeled. According to another feature of the invention, the heat-shrinkable tubing further comprises a plurality of holding slits that are positioned in the tubing into which the identifying label may be secured.

According to yet another aspect of the present invention, the packaging further includes a placard to which the tubing is affixed for use, storage, display, or distribution. The placard may provide support for the tubing as the kit moves through a printing apparatus to be imprinted with an identifying mark. In this manner, the identifying mark may be printed directly on the heat-shrinkable tubing before the tubing is slid over the object's surface, thus removing the need to position a label. The tubing may further include adhesive that coats the inner surface of the tubing to assist in affixing the tubing to the object.

### BRIEF DESCRIPTION OF THE DRAWINGS

The present invention, as well as further objects and features thereof, are more clearly and fully set forth in the following description of the preferred embodiment, which should be read with reference to the accompanying drawings, wherein:

FIG. 1 depicts a generally rounded object, a cowboy lariat, to which the method of the present invention has been applied;

FIG. 2 shows the method of the present invention;

FIG. 3 illustrates an alternative embodiment of the present invention, which comprises holding slits oriented to receive and secure at least a portion of the label;

FIG. 4 depicts yet another embodiment of the present invention comprising a placard having a flap positioned through the tubing to hold the tubing substantially stationary;

FIG. 5 shows positioning of the tubing onto the placard prior to storage, display, and retail distribution of the kit; and

FIG. 6 depicts an alternative embodiment of the present invention, a kit of components comprising a plurality of detachable placards.

### DETAILED DESCRIPTION OF THE PREFERRED EMBODIMENT

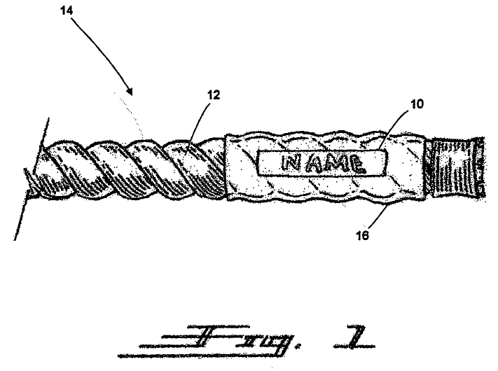

The present invention includes, inter alia, a system and method for labeling non-electrical objects having a generally rounded outer surface, such as ropes (e.g., lariats), cord, tubes, pipes, shafts, string, pencils and pens, or rods. As shown by FIG. 1, a label 10 is secured to the outer surface 12 of a generally rounded object, a cowboy lariat 14, by heat shrinkable tubing 16. By applying heat to the tubing 16, the tubing 16 has constricted around the lariat 14 and conformed to the shape of the outer surface 12 thereof, holding the label 10 stationary relative the outer surface 12.

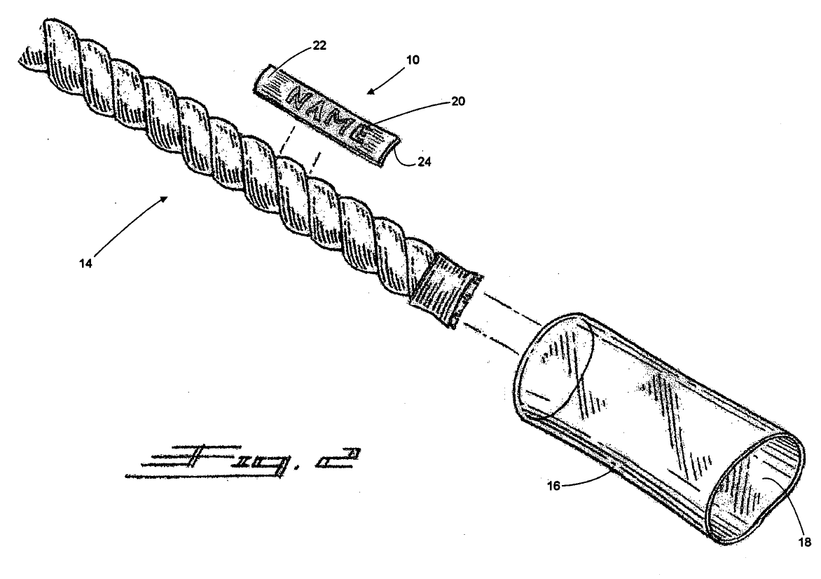

FIG. 2 shows the method of the present invention being applied to a cowboy lariat 14 prior to application of heat to the tubing 16. A heat-shrinkable tubing 16 having an inner surface 18 is slid about the outer surface 12 of the lariat 14. A label 10 comprising an identifying mark 20, a front 22, and a back 24 is positioned on the outer surface 12 of the lariat 14. The sliding of the tubing 16 and the positioning of the label 10 on the outer surface 12 may occur in either order. Moreover, the label 10 may include an adhesive coating (not shown) on the back 24 of the label 10 to aid in positioning thereof during the labeling process.

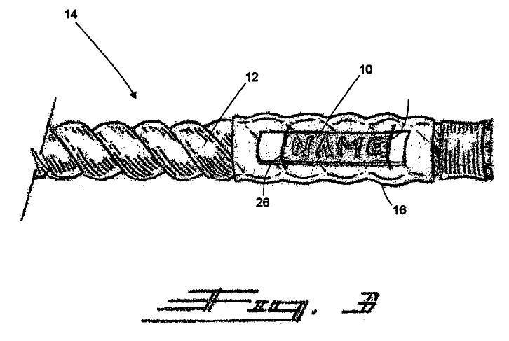

FIG. 3 depicts an alternative embodiment of the present invention in which holding slits 26 are positioned in the tubing 16 and oriented to receive and secure at least a portion of the label 10 between the outer surface 12 of the lariat 14 and the inner surface 18 (shown in FIG. 2) of the tubing 16. Moreover, an adhesive coating (not shown) may be applied to the label 10 to aid in positioning thereof during the labeling process.

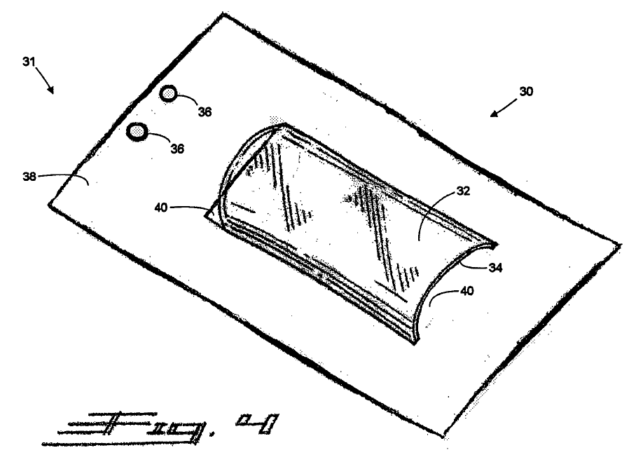

As shown by FIG. 4, the present invention further discloses a kit 30 of components including heat-shrinkable tubing 32 having an inner surface 34 for contacting an object and further comprising packaging suitable for storage, display, and retail distribution of the kit 30. One or more hanger apertures 36 are disposed in a placard 38 for hanging the placard 38 in a retail display. A moveable flap 40 shaped from the placard 38 holds the tubing 32 substantially stationary relative to the placard 38 during display. Moreover, the kit 30 may be run through a typical or customized printer, such as a home-office laser or ink jet printer, for imprinting an identifying mark (not shown) directly on the tubing 32. The placard 38 is between three and nine inches wide by five and eleven inches long.

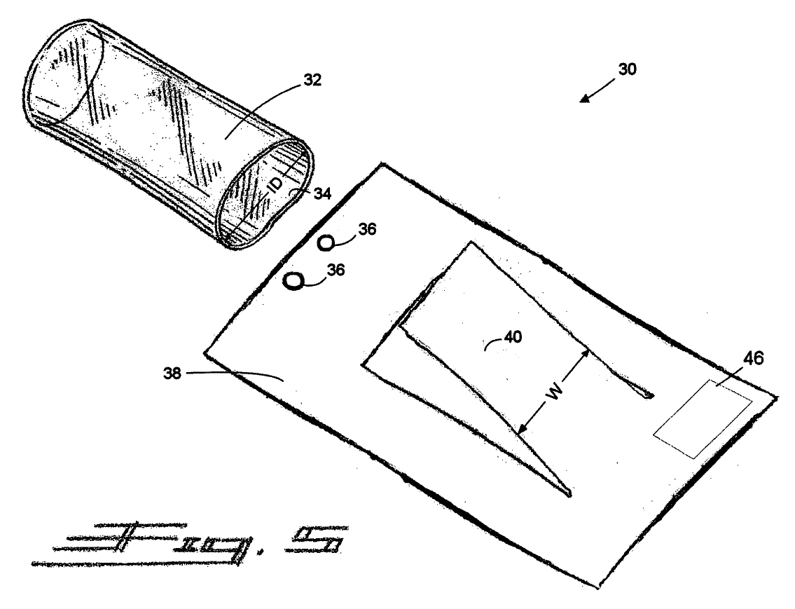

FIG. 5 more clearly shows positioning of the tubing 32 on the flap 40 of the placard 38 for storage, display, retail distribution, and use. According to this embodiment, the flap 40 is situated at a slightly upward (or downward) angle relative to the placard 38 to receive the tubing 32. The width W of the flap 40 is pre-determined based on the inner diameter ID of the tubing 32 so that the tubing 32 will be held taught across the flap 40 when positioned thereover. After placement of the tubing 32 around the flap 40, the flap 40 may be folded down in generally coplanar orientation with the placard 38 for storage, display, retail distribution, or use (as shown in FIG. 4), thereby holding the tubing 32 stationary between the flap 40 and the placard 38. The spacing between the flap 40 and the placard 38 is sufficient to prevent movement of the tubing 32 without indenting or otherwise distressing the tubing 32. Moreover, the flap 40 may be then secured to the placard 38 to prevent subsequent inadvertent upward (or downward) movement of the flap 40 and tubing 32. An instruction label 46 affixed to the placard 38 includes instructions for downloading a printing template from the Internet, which template is of a predefined size.

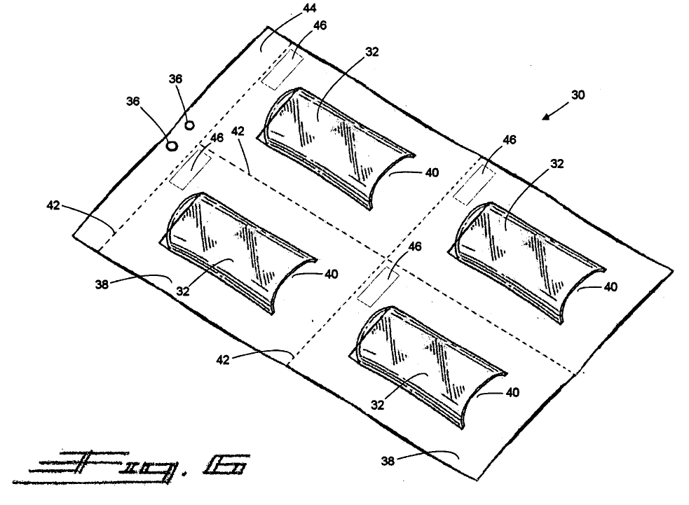

FIG. 6 depicts an alternative embodiment of the present invention, a kit 30 of components comprising a plurality of detachable placards 38 separable along perforated edges 42. Each of the heat-shrinkable tubings 32 are secured to the placards 38 by a flap 40 as described above. One or more hanger apertures 36 are disposed in a hanger 44 for displaying the kit 30. In this manner, each of the placards 38 and tubings 32 secured thereto may be removed as needed and imprinted by a printing apparatus or otherwise used, while the remaining placards 38 and tubings 32 may be stored for later use. The placard size is preferably the same as a standard printing size, such as 8.5″ by 11″ letter paper, 3″ by 5″ index cards, 4″ by 6″ index cards, or No. 10-sized envelopes. Because a feature of the present invention includes a placard preferably selectable from a group of predefined sizes typically used in the home or office setting, the placard may be easily used with existing printing hardware and software. An plurality of instruction labels 46 affixed to the separable placard 38 includes instructions for downloading a printing template from the Internet, which printing template is of a predefined size.

The present invention is described above in terms of preferred illustrative embodiments in which specific kits and methods are described. Those skilled in the art will recognize that alternative constructions can be used in carrying out the present invention. Other aspects, features, and advantages of the present invention may be obtained from a study of this disclosure and the drawings, along with the appended claims.

I claim:

1. A method for labeling a non-electrical object having a generally rounded outer surface comprising:
sliding heat-shrinkable tubing about the outer surface, the tubing having an inner surface for contacting the object's outer surface;
positioning at least a portion of a label on the outer surface, the label having a front for showing an identifying mark and a back for contacting the outer surface; and
heating the tubing at least until at least the portion of the label is held stationary relative to the outer surface by constriction between the inner surface of the tubing and the outer surface of the object.

2. The method of claim 1 wherein the heat-shrinkable tubing is substantially transparent, the method further comprising placing the entire label between the inner surface of the tubing and the outer surface of the object prior to heating.

3. The method of claim 2 wherein the back of the label has an adhesive for bonding the label to the outer surface.

4. The method of claim 1 wherein the heat-shrinkable tubing includes two slits for anchoring a label and the positioning step comprises inserting the label into the holding slits of the tubing.

5. The method of claim 1 further comprising downloading a labeling template from the Internet and using the template to create the label.

6. The method of claim 1 wherein the object is a lariat.

7. The method of claim 1 wherein the object is a rope.

8. A kit of components for labeling a non-electrical object having a generally rounded outer surface, the kit comprising:
a label for identifying the object, the label having a front for showing an identifying mark and a back for contacting the outer surface;
substantially transparent heat-shrinkable tubing having an inner surface for contacting the outer surface and the label to hold the label stationary relative to the outer surface; and
packaging suitable for storage, display, and retail distribution.

9. The kit of claim 8 further comprising adhesive, the adhesive coating at least a portion of the back of the label.

10. The kit of claim 8, further comprising at least two holding slits, the holding slits positioned in the tubing and oriented to receive and secure at least a portion of the label between the outer surface of the object and the inner surface of the tubing.

11. The kit of claim 8 further comprising instructions for downloading a labeling template from the Internet and using the template to create the label.

12. A kit of components for labeling a non-electrical object having a generally rounded outer surface, the kit comprising:
heat-shrinkable tubing having an inner surface for contacting the outer surface; and
a placard for storage, display, and retail distribution of the kit, the placard being sized for feeding through a printing apparatus for labeling purposes, the placard further holding the heat-shrinkable tubing flat so that the placard can be fed through the printing apparatus in order to label the tubing.

13. The kit of claim 12, wherein the placard has a flap positioned through the tubing to hold the tubing substantially stationary relative to the placard during storage, display, distribution, and use of the kit.

14. The kit of claim 13 further comprising instructions for downloading a labeling template from the Internet and using the template to create the label.
